(19) United States
(12) Patent Application Publication
(10) Pub. No.: US 2009/0211859 A1
(43) Pub. Date: Aug. 27, 2009

(54) SOLENOID VALVE ASSEMBLY OF SHOCK ABSORBER

(75) Inventor: Kyu Shik Park, Seoul (KR)

Correspondence Address: SEED INTELLECTUAL PROPERTY LAW GROUP PLLC, 701 FIFTH AVE, SUITE 5400, SEATTLE, WA, 98104, US

(73) Assignee: Mando Corporation, Pyeongtaek-si (KR)

(21) Appl. No.: 12/393,488

(22) Filed: Feb. 26, 2009

(30) Foreign Application Priority Data
Feb. 26, 2008 (KR) 10-2008-0017160

(51) Int. Cl. F16F 9/34

(52) U.S. Cl. 188/266.6

(57) ABSTRACT

Disclosed is a solenoid valve assembly of a shock absorber wherein a plug the position of which is threadedly adjusted is prevented from escaping. The solenoid valve assembly includes a tubular spool rod having a female threaded portion formed on one end thereof, a plug including a male threaded portion threadedly coupled to the female threaded portion and a head portion having a diameter lager than that of the male threaded portion, the plug being threadedly adjusted in position with respect to the spool rod. The assembly further includes one or more ring-shaped spacers positioned adjacent or contiguous the male threaded portion for filling a space between an end surface of the spool rod and the head portion, thereby providing fixing torque to the plug the position of which is adjusted.

### BACKGROUND

1. Technical Field

The present disclosure relates to a solenoid valve assembly of a shock absorber, and more particularly, to a solenoid valve assembly of a shock absorber having a plug the position of which is adjusted in a manner to prevent it from escaping.

2. Description of the Related Art

In general, a vehicle is provided with a shock absorber for absorbing and relieving shocks or vibrations transmitted from a road surface or a portion of the vehicle while the vehicle is driven. Damping force of the shock absorber has influence on ride comfort as well as handling stability of the vehicle. For example, lower damping force of the shock absorber enhances the ride comfort but deteriorates the handling stability of the vehicle. In view of the above, when the vehicle is turned, accelerated, braked or traveled at high speed, there is need to enhance the handling stability of a vehicle by increasing damping force and thus restraining a posture change of a vehicle body.

A shock absorber, which can adjust a damping characteristic in order to relatively enhance the ride comfort or handling stability according to the driving condition of a vehicle and a condition of a road surface on which the vehicle is driven, has been well known. In general, the above shock absorber is referred to as a damping force variable shock absorber. The damping force variable shock absorber is provided with a damping force variable solenoid valve assembly for adjusting a damping force characteristic. The solenoid valve assembly is configured such that a flow passage through which oil introduced from the shock absorber flows is varied in response to an electric signal, and resistance against the oil is increased or reduced according to the changed flow passage to thereby adjust the damping force.

The solenoid valve assembly comprises a tubular spool rod having a plurality of bores formed thereon and a spool slidably inserted into and installed to the spool rod. The bores of the spool rod communicate with chambers defined by valve seats and retainers, and a flow passage between the chambers can be varied according to a change of position of the spool, which makes it possible to adjust damping force. The spool moves forward or backward by a compressing rod coupled to a plunger of a solenoid at one end of the spool, thereby being changed in position with respect to the bores of the spool rod. In general, the compressing rod moves forward by electric power supplied to a bobbin of the solenoid, thereby pushing the spool in one direction and moving the spool forward. In addition, since a spring supported by a plug applies force to the other end of the spool in a direction in which the spool retreats, the spool can be moved backward when the compressing rod retreats. The plug supports the aforementioned spring in a state where the plug is threadedly coupled to the spool rod.

In the solenoid valve assembly, it is important to accurately set an initial position of the spool with respect to the bore of the spool rod. This is because in a process of assembling the solenoid valve assembly, there is a machining tolerance of the spring, the plunger, the compressing rod, the spool, the spool rod having the bores formed, or the plug. In order to prevent an assembling error caused by the machining tolerance, a process of setting the initial position of the spool with respect to the bore of the spool rod is performed. Through adjustment of a position of the plug with respect to the spool rod performed in a screw manner and a subsequent test for a pressure-flow rate characteristic according to a current change, the initial position of the spool with respect to the bore of the spool rod is set. After the initial position is set, a threaded portion of the plug is coated with polymer to provide torque against rotational escape of the plug, so that the position of the plug is fixed. Korean Patent No. 10-0558517 registered in the name of the present applicant discloses a technique for set an initial position of a spool by a plug.

In the prior art, however, when an excessive pressure is generated in the plug, torque exceeding permissible torque against which the polymer can withstand is generated, which causes the position of the plug to be changed in an undesirable direction or the plug to escape, thereby resulting in inferior ride comfort and damage or other problems to the solenoid valve assembly. In a process of assembling the plug, furthermore, foreign materials are generated, such as the polymer coating layer peels away, and the foreign materials can be introduced into the solenoid valve assembly, hindering the spool from smoothly moving.

### BRIEF SUMMARY

Accordingly, an object of embodiments the present invention is to provide a solenoid valve assembly of a shock absorber, wherein large fixing torque is exerted on a plug, the position of which is adjusted, without a polymer coating layer to prevent the plug from being undesirably displaced or escaping and to fundamentally prevent foreign materials caused by a polymer coating layer peeling away.

According to an aspect, there is provided a solenoid valve assembly of a shock absorber, which comprises a tubular spool rod having a female threaded portion formed on one end thereof; a plug including a male threaded portion threadedly coupled to the female threaded portion and a head portion having a diameter lager than that of the male threaded portion, the plug being threadedly adjusted in position with respect to the spool rod; and one or more ring-shaped spacers positioned adjacent or contiguous to the male threaded portion for filling a space between an end surface of the spool rod and the head portion, thereby providing fixing torque to the plug the position of which is adjusted.

In one embodiment, the ring-shaped spacer is elastically deformable and has a shape with a portion opened so that the ring-shaped spacer can be positioned adjacent or contiguous to the plug without separating the plug from the spool rod.

In one embodiment, the number of the ring-shaped spacers and thickness thereof are selected according to a gap between the head part and the end surface of the spool rod, and the ring-shaped spacers are positioned on the plug.

### BRIEF DESCRIPTION OF THE SEVERAL VIEWS OF THE DRAWINGS

FIG. 1 is a partial cross-sectional view illustrating a damping force variable shock absorber provided with a solenoid valve assembly according to one embodiment;

FIG. 2 is a cross-sectional view illustrating a solenoid valve assembly of a shock absorber according to one embodiment;

FIG. 3 is a plan view illustrating a spacer for providing fixing torque to a plug according to one embodiment; and

FIGS. 4(a) and 4(b) are cross-sectional views illustrating a portion of a solenoid valve assembly at different stages of a method of providing fixing torque using a spacer according to one embodiment.

### DETAILED DESCRIPTION

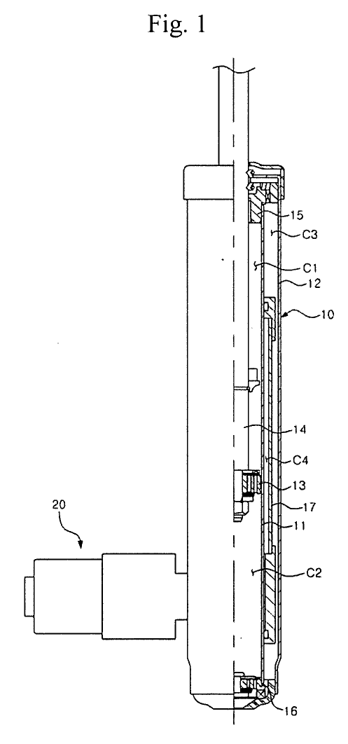

Referring to FIG. 1, a damping force variable shock absorber according to one embodiment includes a shock absorber main body 10 and a solenoid valve assembly 20 fixedly coupled to one side surface of the shock absorber main body 10 to variably control damping force. An inlet and an outlet of the solenoid valve assembly 20 are connected to a high pressure part and a low pressure part of the shock absorber body 10, respectively, so that the solenoid valve assembly 20 is supplied with oil from the high pressure part of the shock absorber main body 10 through the inlet and the oil is discharged to the low pressure part of the shock absorber body 10 through the outlet.

The shock absorber main body 10 comprises a inner tube 11, an outer tube 12 outside thereof, a piston valve 13 received in the inner tube 11, and a piston rod 14 having one end connected to the piston valve 13. The piston rod 14 is slidably supported by a rod guide 15 installed toward an upper end of the inner and outer tubes 11 and 12.

The piston valve 13 divides an inside of the inner tube 11 into an upper rebound chamber C1 and a lower compression chamber C2. The piston valve 13 has the configuration by which oil flow from the rebound chamber C1 to the compression chamber C2 and oil flow in an opposite direction thereto are selectively allowed according to up and down movement of the piston valve. The oil can flow between the compression chamber C2 and the rebound chamber C1 to generate predetermined damping force due to flow passage resistance.

In order to compensate for a volume change of the compression chamber C2, a reservoir chamber C3 which is partially filled with oil is provided between the inner tube 11 and the outer tube 12. When volume of the compression chamber C2 is changed by movement of the piston valve 13 and accordingly pressure in the compression chamber is changed, the oil in the reservoir chamber C3 is supplied to the compression chamber C2 or oil is recovered from the compression chamber C2 to the reservoir chamber C3. In addition, a body valve 16 is fixedly installed between the reservoir chamber C3 and the compression chamber C2, specifically toward a lower end of the inner and outer tubes 11 and 12, and the body valve 16 is also provided with a device configured to generate flow passage resistance against oil flow. Accordingly, predetermined damping force can be generated by oil flow between the reservoir chamber C3 and the compression chamber 12.

Furthermore, an intermediate tube 17, which cooperates with the inner tube 11 to define a high pressure tube C4, is installed between the inner tube 11 and the outer tube 12. The high pressure tube C4 can fluidly communicate with an inside of the inner tube 11, i.e., the rebound chamber C1 and/or the compression chamber C2, for example through an aperture (not shown) formed on the inner tube 11. In one embodiment, the solenoid valve assembly 20 is supplied with high pressure oil from the high pressure chamber C4 and itself changes a flow passage, through which oil flows, to adjust damping force of the shock absorber.

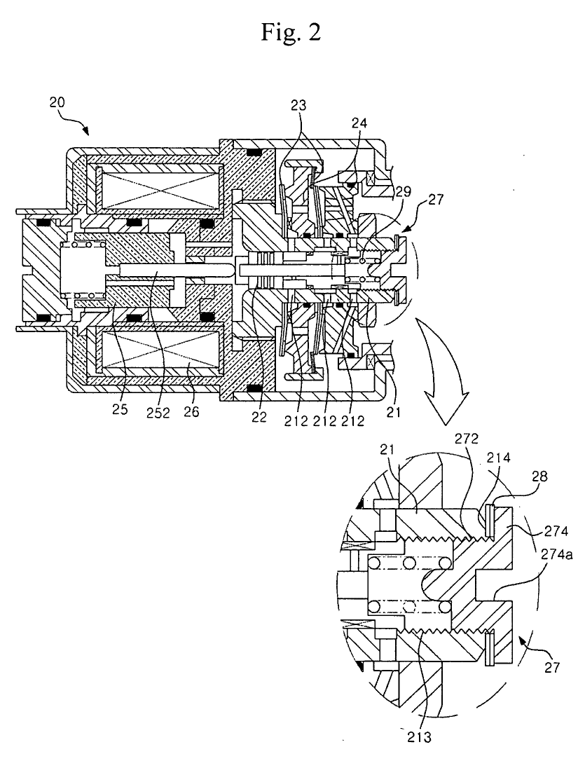

FIG. 2 shows a solenoid valve assembly according to one embodiment.

Referring to FIG. 2, the solenoid valve assembly 20 of this embodiment includes a tubular spool rod 21 having a plurality of bores 212 formed thereon and a spool 22 slidably inserted into and installed to the spool rod 21. The bores of the spool rod 21 communicate with chambers defined by valve seats 23 and valve retainers 24, and a flow passage between the chambers can be varied according to a change of a position of the spool 22, which makes it possible to adjust damping force. The spool 22 moves forward or backward by a compressing rod 252 coupled to a plunger 25 at one end of the spool, thereby its position varying with respect to the bores 212 of the spool rod 21. The compressing rod 252 moves forward by electric power supplied to a bobbin 26 to thereby push the spool 22 in one direction and to move the spool.

Furthermore, the solenoid valve assembly 20 includes a plug 27 for setting an initial position of the spool 22. The spool 22 is disposed such that one end thereof is linearly moved by the compressing rod 252, while the other opposite end receives a biasing force from a biasing member, such as a spring 29 supported by the plug 27. Accordingly, when the compressing rod 252 retreats, the spool 22 can retreat together with the compressing rod 252 by the biasing force.

A female threaded portion 213 is formed on one end of the spool rod 21, and the plug 27 is provided with a male threaded portion 272 threadedly coupled to the female threaded portion 213 of the spool rod 21. Also, the plug 27 is provided with a head portion 274 which has a diameter larger than that of the male threaded portion 272 and is formed on a proximal end of the male threaded portion 272. A wrench groove 274a is formed on the head part 274, and a wrench (not shown) which is a kind of a screw fastening tool can be inserted into the wrench groove 274a. By rotating the wrench, the male threaded portion 272 of the plug 27 is moved forward or backward along the female threaded portion 213 of the spool rod 21, whereby a position of the plug 27 is adjusted. Through the position adjustment of the plug 27, a position of the spool 22 with respect to the bore 212 of the spool rod 21 is also adjusted. At this time, through the position adjustment of the spool 22 and a subsequent test for a pressure-flow rate characteristic according to a current change, the initial position of the spool 22 with respect to the bore 212 of the spool rod 21 is set.

After the position adjustment of the plug 27 and accordingly the setting of the initial position of the spool 22, a device configured to provide a fixing torque to the plug 27 the position of which is adjusted is provided or formed on the plug 27. In the prior art, a polymer layer applied to a plug is intended to provide a fixing torque to the plug 27. The solenoid valve assembly according to one inventive embodiment of the present disclosure includes one or more ring-shaped spacers which are positioned adjacent or contiguous to the male threaded portion of the plug 27 so as to fill a space between an end surface 214 of the spool rod 21 and the head portion 274 of the plug 27.

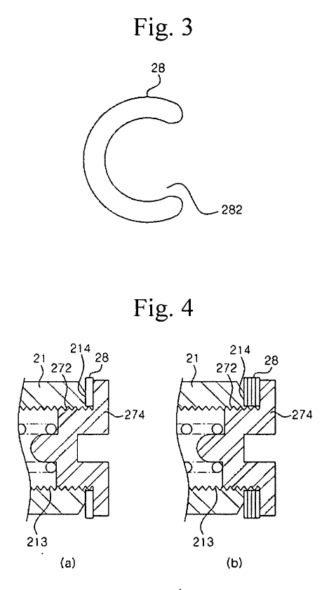

The ring-shaped spacer 28 can be elastically deformable and has a shape with a portion opened so that the ring-shaped spacer can be positioned adjacent or on the male threaded portion 272 of the plug 27 without separating the plug from the spool rod 21. As shown in FIG. 3, for example, the ring-shaped spacer 28 may have a “C” shape with a portion generally opened. The ring-shaped spacer 28 can be fitted on the male threaded portion 272 of the plug 27 while an open portion 282 of the ring-shaped spacer is forcibly widened. Then, since the ring-shaped spacer 28 is elastically deformable, the spacer fit on the male threaded portion 272 is elastically restored to its origin shape.

In the meantime, as shown in FIGS. 4(a) and 4(b), according to the adjusted position of the plug 27, a gap between the head part 274 of the plug 27 and the end surface 214 of the spool rod 21 can be changed. The number of the ring-shaped spacers 28 and the thickness thereof can be selected according to the gap, and then the spacers may be fit on the plug 27.

According to embodiments of the present invention, there is an advantage in that large fixing torque can be exerted on the plug, the position of which is adjusted, without a polymer coating layer to thereby prevent the plug from being undesirably displaced or escaping and to fundamentally prevent foreign materials caused by peeling away a polymer coating layer from occurring.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A solenoid valve assembly of a shock absorber, comprising:
a tubular spool rod having a female threaded portion formed toward one end thereof;
a plug including a male threaded portion threadedly coupled to the female threaded portion and a head portion having a diameter lager than a diameter of the male threaded portion, the plug being threadedly adjusted in position with respect to the spool rod; and
one or more ring-shaped spacers positioned adjacent the male threaded portion to fill a space between an end surface of the spool rod and the head portion, and provide fixing torque to the plug the position of which is adjusted.

2. The solenoid valve assembly of claim 1 wherein the ring-shaped spacer is elastically deformable and has a shape with a portion opened, the ring-shaped spacer being positioned on a portion of the plug without separating the plug from the spool rod.

3. The solenoid valve assembly of claim 1 wherein a quantity of the ring-shaped spacers and thickness thereof are selected according to a gap between the head portion and the end surface of the spool rod, and the ring-shaped spacers are positioned on the plug.
